(19) United States
(12) Patent Application Publication
(10) Pub. No.: US 2026/0094373 A1
(43) Pub. Date: Apr. 2, 2026

(54) IMAGE EFFECT RENDERING METHOD AND APPARATUS, DEVICE, AND STORAGE MEDIUM

(71) Applicant: Beijing Zitiao Network Technology Co., Ltd., Haidian District (CN)

(72) Inventors: Chunlei RUAN, Beijing (CN); Ruchong LUO, Beijing (CN)

(21) Appl. No.: 19/316,865

(22) Filed: Sep. 2, 2025

(30) Foreign Application Priority Data
Sep. 29, 2024 (CN) 202411379762.7

(51) Int. Cl. G06T 17/20; G06T 7/40

(52) U.S. Cl. CPC G06T 17/20; G06T 7/40

(57) ABSTRACT

Embodiments of the present disclosure provide an image effect rendering method and apparatus, a device, and a storage medium. The method includes: determining, in response to an effect rendering operation on a target image, texture information corresponding to the target image; acquiring image effect information corresponding to the target image from the texture information, where the image effect information includes object position information, object rendering information, and object display information of at least one effect object; and rendering the target image based on the object position information, the object rendering information, and the object display information of the at least one effect object included in the image effect information.

### CROSS-REFERENCE TO RELATED APPLICATION(S)

This application claims priority to Chinese Application No. 202411379762.7 filed on Sep. 29, 2024, the disclosure of which is incorporated herein by reference in its entirety.

### FIELD

Embodiments of the present disclosure relate to the technical field of video editing, and in particular, to an image effect rendering method and apparatus, a device, and a storage medium.

### BACKGROUND

With the development of video editing technology, an increasing number of users choose to edit videos using video editing software. For example, after an image effect is added to a video image, the image effect needs to be rendered.

In the prior art, when rendering the image effect, it is necessary to first determine position information corresponding to each of a plurality of effect objects within the image effect. Then, the plurality of effect objects are sequentially rendered based on the position information of each effect object.

However, the inventor has found that at least the following technical problems exist in the prior art: since a rendering process for the plurality of effect objects is performed sequentially, when there are a large number of effect objects, the rendering time required is longer, resulting in low rendering efficiency for the image effect.

### SUMMARY

Embodiments of the present disclosure provide an image effect rendering method and apparatus, a device, and a storage medium.

In a first aspect, an embodiment of the present disclosure provides an image effect rendering method, including:
determining, in response to an effect rendering operation on a target image, texture information corresponding to the target image;
acquiring image effect information corresponding to the target image from the texture information, where the image effect information includes object position information, object rendering information, and object display information of at least one effect object; and
rendering the target image based on the object position information, the object rendering information, and the object display information of the at least one effect object included in the image effect information.

In a second aspect, an embodiment of the present disclosure provides an image effect rendering apparatus, including:
a determination module configured to determine, in response to an effect rendering operation on a target image, texture information corresponding to the target image;
an acquiring module configured to acquire image effect information corresponding to the target image from the texture information, where the image effect information includes object position information, object rendering information, and object display information of at least one effect object; and
a rendering module configured to render the target image based on the object position information, the object rendering information, and the object display information of the at least one effect object included in the image effect information.

In a third aspect, an embodiment of the present disclosure provides an electronic device, including: a processor and a memory.

The memory stores computer-executable instructions.

The processor executes the computer-executable instructions stored in the memory, to cause the at least one processor to perform the image effect rendering method according to the first aspect and various possible designs in the first aspect described above.

In a fourth aspect, an embodiment of the present disclosure provides a computer-readable storage medium, storing computer-executable instructions which, when executed by a processor, implement the image effect rendering method according to the first aspect and various possible designs in the first aspect described above.

In a fifth aspect, an embodiment of the present disclosure provides a computer program product, including a computer program. The computer program, when executed by a processor, implements the image effect rendering method according to the first aspect and various possible designs in the first aspect described above.

### BRIEF DESCRIPTION OF THE DRAWINGS

In order to describe the technical solutions in embodiments of the present disclosure or the prior art more clearly, the accompanying drawings required for describing the embodiments or the prior art will be briefly introduced below. Apparently, the accompanying drawings described below are some embodiments of the present disclosure, and those of ordinary skill in the art may also derive other accompanying drawings from these accompanying drawings without creative efforts.

FIG. 1 is a schematic diagram of an application scenario of an image effect rendering method according to an embodiment of the present disclosure;

FIG. 2 is a first flowchart of an image effect rendering method according to an embodiment of the present disclosure;

FIG. 3 is a first schematic diagram of an image effect rendering method according to an embodiment of the present disclosure;

FIG. 4 is a second flowchart of an image effect rendering method according to an embodiment of the present disclosure;

FIG. 5 is a schematic structural diagram of an image effect rendering apparatus according to an embodiment of the present disclosure; and

FIG. 6 is a schematic structural diagram of an electronic device according to an embodiment of the present disclosure.

### DETAILED DESCRIPTION OF EMBODIMENTS

In order to have a clearer understanding of the objectives, technical solutions, and advantages of embodiments of the present disclosure, the technical solutions in the embodiments of the present disclosure are clearly and completely described in conjunction with the accompanying drawings in the embodiments of the present disclosure, and it is apparent that the described embodiments are only a part rather all of embodiments of the present disclosure. Based on the embodiments of the present disclosure, all other embodiments obtained by those of ordinary skill in the art without contributing creative work shall fall within the scope of protection of the present disclosure.

With the development of video editing technology, an increasing number of users choose to edit videos using video editing software. For example, after an image effect is added to a video image, the image effect needs to be rendered.

In the prior art, when rendering the image effect, it is necessary to first determine position information corresponding to each of a plurality of effect objects within the image effect. Then, the plurality of effect objects are sequentially rendered based on the position information of each effect object. However, since a rendering process for the plurality of effect objects is performed sequentially, when there are a large number of effect objects, the rendering time required is longer, resulting in low rendering efficiency for the image effect.

Therefore, how to shorten the time spent on rendering the effect objects and improve the rendering efficiency of the image effect is a technical problem that urgently needs to be solved at present.

For the technical problem in the prior art, technical ideas of the inventor in the process of solving the above-mentioned technical problem are as follows: achieving synchronous rendering of the plurality of effect objects to shorten the rendering time of the plurality of effect objects to improve the rendering efficiency of the image effect. How can synchronous rendering of the plurality of effect objects be achieved? This application utilizes color channels of a texture image to store rendering information of a video effect. When rendering the video effect, rendering information of a plurality of effect objects is simultaneously acquired from texture information, thereby achieving synchronous rendering of the plurality of effect objects.

The specific steps may include: first, determining, in response to an effect rendering operation on a target image, texture information corresponding to the target image. Then, image effect information corresponding to the target image is acquired from the texture information. The image effect information includes object position information, object rendering information, and object display information of at least one effect object. Finally, the target image is rendered based on the object position information, the object rendering information, and the object display information of the at least one effect object included in the image effect information.

In the technical solution, when rendering the image effect, the rendering information of the plurality of effect objects may be simultaneously acquired from the texture information, thereby achieving synchronous rendering of the plurality of effect objects, and thus improving the rendering efficiency of the image effect.

The following are explanations of application scenarios and technical terms involved in the embodiments of the present disclosure:

Texture information: an image includes a plurality of texture pixels, and a single texture pixel may include four information channels: a red information channel, a green information channel, a blue information channel, and a transparency information channel. Each information channel may store 8-bit data. Information stored in the four information channels corresponding to each texture pixel constitutes the texture information of the image. In this embodiment of the present disclosure, the information channels may store color information, and may also store other information such as coordinate information and area information.

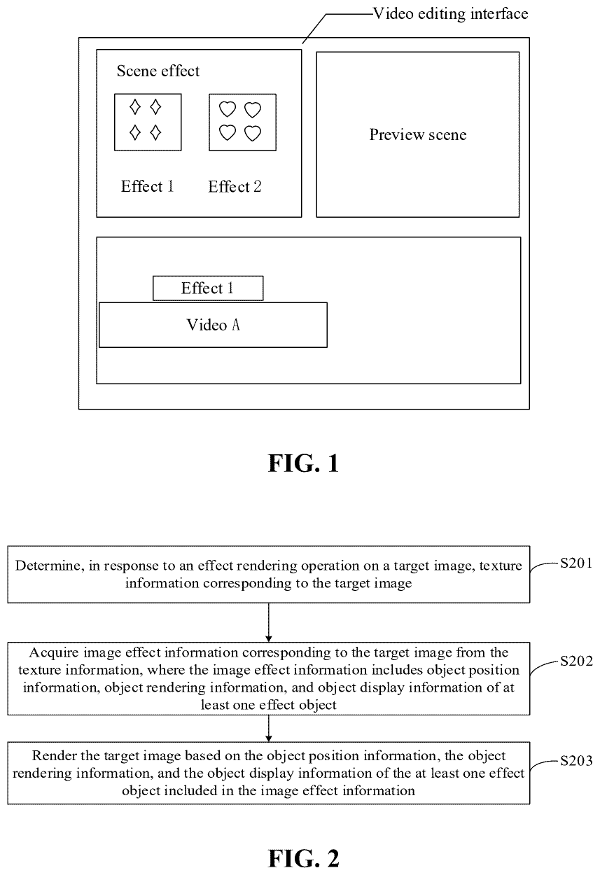

An image effect rendering method according to this embodiment of the present disclosure may be applied to a scenario where various video effects are rendered. FIG. 1 is a schematic diagram of an application scenario of an image effect rendering method according to an embodiment of the present disclosure. As shown in FIG. 1, an image effect is achieved by adding an effect 1 (a plurality of star patterns) to a video image, thereby improving a video image display effect. In this case, through the image effect rendering method provided in this embodiment of the present disclosure, the plurality of star patterns may be rendered in parallel to improve the image effect rendering efficiency.

The following is a specific implementation process of the image effect rendering method and apparatus, a device, and a storage medium involved in the embodiments of the present disclosure, with some examples provided for illustration only and not as limitations. An executing entity of a material processing method involved in this embodiment of the present disclosure is an electronic device, which may be a mobile phone, a computer, a calculator, a tablet, a server, etc.

FIG. 2 is a first schematic flowchart of an image effect rendering method according to an embodiment of the present disclosure. As shown in FIG. 2, the image effect rendering method may include following steps.

At S201, in response to an effect rendering operation on a target image, texture information corresponding to the target image is determined.

In this embodiment of the present disclosure, the target image to be rendered may be an edited image imported into editing software or a certain video frame in an edited video.

Optionally, the texture information corresponds to an effect mode, and different effect modes correspond to different texture information. The effect mode may be any form of effect, such as a scene effect, a character effect or the like. For example, an XX effect may be achieved by adding a plurality of effect objects to an image.

In some embodiments, in response to the effect rendering operation on the target image, texture information corresponding to the target image being determined includes: determining an effect mode corresponding to the effect rendering operation in response to the effect rendering operation on the target image; and determining the texture information corresponding to the target image from a correspondence relationship between effect modes and texture information.

It should be noted that the texture information may be a texture image with a preset size. For example, the texture image with the preset size includes 128*64 texture pixels. Each texture pixel includes 4 color channels. In this case, object position information, object rendering information, and object display information of the plurality of effect objects may be stored in the color channels of the 128*64 texture pixels.

At S202, image effect information corresponding to the target image is acquired from the texture information. The image effect information includes object position information, object rendering information, and object display information of at least one effect object.

The object position information may be a position of the effect object in the image. Optionally, the object position information includes an X-coordinate and a Y-coordinate. The X-coordinate and Y-coordinate may be normalized coordinates. For example, the normalized X-coordinate and Y-coordinate (0.5, 0.5) represent a center position of the image.

The object rendering information may be any attribute information of the effect object. For example, the object rendering information may be an object rendering area of the effect object. The larger the object rendering area, the greater a rendering region of the effect object. In this case, by setting the object rendering information of the plurality of effect objects, the plurality of effect objects of different sizes may be displayed. As another example, the object rendering information may be the transparency of the effect object. The larger the object rendering information, the higher the transparency. In this case, by setting the object rendering information of the plurality of effect objects, the plurality of effect objects of different transparencies may be displayed.

In this embodiment of the present disclosure, for an effect object associated with each object position information, whether to display the effect object associated with the object position information may be configured through the object display information. Optionally, the object display information is used for indicating whether the effect object is displayed in the image. Optionally, the object display information includes 255 or 0. When the object display information is 255, it indicates that the effect object is displayed; and when the object display information is 0, it indicates that the effect object is not displayed.

At S203, the target image is rendered based on the object position information, the object rendering information, and the object display information of the at least one effect object included in the image effect information.

In some embodiments, a grid region corresponding to a grid vertex may display the effect object corresponding to the image effect information, or may also display other effect objects outside the image effect information. In this case, the content to be displayed in the grid region corresponding to the grid vertex may be flexibly configured through the object display information. Correspondingly, this step may include: for each effect object, in response to the object display information being used for indicating displaying the effect object, determining a rendering region of the effect object based on the object position information and the object rendering information of the effect object, and rendering the effect object in the rendering region; and in response to the object display information being used for indicating not displaying the effect object, not rendering the effect object.

Exemplarily, the object display information includes 255 or 0. When the object display information is 255, it indicates that the effect object in the image effect information is displayed; and when the object display information is 0, it indicates that the effect object in the image effect information is not displayed.

Optionally, determining the rendering region of the effect object based on the object position information and the object rendering information of the effect object, and rendering the effect object in the rendering region includes: in response to the object rendering information including an object rendering area, determining the rendering region of the effect object based on the object rendering area of the effect object, and rendering the effect object in the rendering region. A size of a target effect object in the rendering region in the grid region matches the object rendering area, with a larger object rendering area corresponding to a larger rendering region. In this case, by setting the object rendering information of the plurality of effect objects, the plurality of effect objects of different sizes may be displayed.

In response to the object rendering information including a rendering transparency, the rendering region of the effect object is determined based on the object position information and a preset object rendering area, and the effect object is rendered in the rendering region based on the rendering transparency. In this embodiment of the present disclosure, a value of the preset object rendering area is not specifically limited and may be set and modified as needed. The larger the object rendering information, the higher the transparency. In this case, by setting the object rendering information of the plurality of effect objects, the plurality of effect objects of different transparencies may be displayed.

In this embodiment of the present disclosure, the rendering information (the object position information, the object rendering information, and the object display information) for the plurality of effect objects may be invoked from the texture information in parallel, and the target image may rendered through parallel rendering of the plurality of effect objects.

According to the image effect rendering method provided in this embodiment of the present disclosure, first, in response to the effect rendering operation on the target image, the texture information corresponding to the target image is determined. Then, the image effect information corresponding to the target image is acquired from the texture information. The image effect information includes the object position information, the object rendering information, and the object display information of the at least one effect object. Finally, the target image is rendered based on the object position information, the object rendering information, and the object display information of the at least one effect object included in the image effect information. In the technical solution, when rendering the image effect, the rendering information of the plurality of effect objects may be simultaneously acquired from the texture information, thereby achieving synchronous rendering of the plurality of effect objects, and thus improving the rendering efficiency of the image effect.

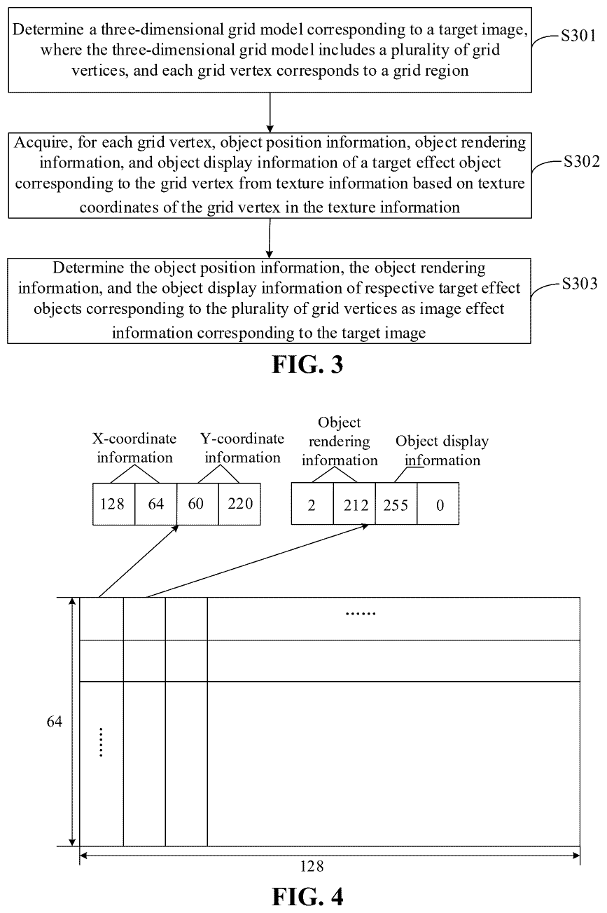

FIG. 3 is a second schematic flowchart of an image effect rendering method according to an embodiment of the present disclosure. In this embodiment of the present disclosure, a method for acquiring the image effect information corresponding to the target image from the texture information in step S203 is elaborated in detail. As shown in FIG. 3, the method may include the following steps.

At S301, a three-dimensional grid model corresponding to the target image is determined. The three-dimensional grid model includes a plurality of grid vertices, and each grid vertex corresponds to a grid region.

Optionally, the three-dimensional grid model may be a mesh grid model corresponding to the image, where the mesh grid model is composed of a plurality of small planes (or referred to as patches). The mesh grid model specifies information such as a shape, vertex coordinates, and normal directions of the patches of the three-dimensional model. Once the information is defined, a basic shape of an object in a three-dimensional space is determined.

At S302, for each grid vertex, object position information, object rendering information, and object display information of the target effect object corresponding to the grid vertex is acquired from the texture information based on texture coordinates of the grid vertex in the texture information.

Optionally, the texture coordinates include x-texture coordinates and y-texture coordinates. When the number of texture pixels corresponding to the target effect object is one, the texture coordinates include one set of coordinates corresponding to one texture pixel. When there are a plurality of texture pixels corresponding to the target effect object, the texture coordinates include a plurality of sets of coordinates, corresponding to the plurality of texture pixels.

It should be noted that the texture information may be a texture image with a preset size. Exemplarily, the texture information includes 128*64 texture pixels. Texture coordinates (120, 60) correspond to the texture pixel in the 120^{th} row and 60^{th} column. Texture coordinates (120, 60) and (120, 61) correspond to the texture pixel in the 120^{th} row and 60^{th} column and the texture pixel in the 120^{th} row and 61^{st} column.

In this embodiment of the present disclosure, the object position information, the object rendering information, and the object display information of the target effect object corresponding to the grid vertex may be acquired from a color channel corresponding to one or more texture pixels. Correspondingly, for each grid vertex, the object position information, the object rendering information, and the object display information of the target effect object corresponding to the grid vertex being acquired from the texture information based on texture coordinates of the grid vertex in the texture information includes: for each grid vertex, determining at least one texture pixel corresponding to the grid vertex from the texture information based on texture coordinates of the grid vertex in the texture information; and acquiring the object position information, the object rendering information, and the object display information corresponding to the target effect object from a color channel of the at least one texture pixel.

In some embodiments, the number of at least one texture pixel is one; and the color channel of the texture pixel include a red information channel, a green information channel, a blue information channel, and a transparency information channel. Correspondingly, acquiring the object position information, the object rendering information, and the object display information of the target effect object corresponding to the grid vertex from the color channel of the at least one texture pixel includes: acquiring X-coordinate information in the object position information of the target effect object from the red information channel of the texture pixel; acquiring Y-coordinate information in the object position information of the target effect object from the green information channel of the texture pixel; acquiring the object rendering information of the target effect object from the blue information channel of the texture pixel; and acquiring the object display information of the target effect object from the transparency information channel of the texture pixel.

In this embodiment of the present disclosure, the amount of information stored in the color channel of each texture pixel is limited. For example, a color channel may store 8 bytes of data. In this case, to improve the accuracy of the information, the information may be stored through the color channels of the plurality of texture pixels. The effect object corresponds to the plurality of texture pixels, and the color channels of the plurality of texture pixels are used to store the rendering information of the effect object. In this case, the plurality of texture pixels corresponding to each effect object may constitute the texture information corresponding to the target image.

In some other embodiments, the at least one texture pixel includes a first texture pixel and a second texture pixel which are adjacent in position. Correspondingly, acquiring the object position information, the object rendering information, and the object display information of the target effect object corresponding to the grid vertex from the color channel of the at least one texture pixel includes: acquiring X-coordinate information in the object position information of the target effect object from a red information channel and a green information channel of the first texture pixel; acquiring Y-coordinate information in the object position information of the target effect object from a blue information channel and a transparency information channel of the first texture pixel; acquiring the object rendering information of the target effect object from a red information channel and a green information channel of the second texture pixel; and acquiring the object display information of the target effect object from a blue information channel of the second texture pixel.

Exemplarily, as shown in FIG. 4, the texture image includes 128*64 texture pixels. The X-coordinate information (128, 64) in the object position information of the target effect object is acquired from the red information channel and the green information channel of the first texture pixel. The Y-coordinate information (60, 220) in the object position information of the target effect object is acquired from the blue information channel and the transparency information channel of the first texture pixel. The object rendering information (2, 212) of the target effect object is acquired from the red information channel and the green information channel of the second texture pixel. The object display information (255) of the target effect object is acquired from the blue information channel of the second texture pixel. The object rendering information may be represented as: weight. The object display information may be represented as: flag. The transparency information channel of the second texture pixel does not store information, which may be represented as: null.

It should be noted that a data format stored in the color channels of the texture pixels is an unsigned character format. A numerical range of the data format is: 0 to 255. In this example, the first X-coordinate information 128, after normalization, has a value of 128/255=0.5, which is also a center of an image X direction. The second X-coordinate information 64, after normalization, has a value of 64/255=0.25, which is located after the first X-coordinate information 0.5, namely, 0.525. Apparently, by storing the two pieces of X-coordinate information, the accuracy of the X-coordinate information can be improved. It should be understood that by storing two pieces of Y-coordinate information, the accuracy of the Y-coordinate information can be improved, and by storing two pieces of object rendering information, the accuracy of the object rendering information can be improved.

In this embodiment of the present disclosure, the object position information, the object rendering information, and the object display information of the target effect object corresponding to the grid vertex are acquired from the color channels of the two texture pixels, thereby improving the accuracy of the information.

At S303, the object position information, the object rendering information, and the object display information of respective target effect objects corresponding to the plurality of grid vertices are determined as the image effect information corresponding to the target image.

It should be noted that before determining the texture information corresponding to the target image from the correspondence relationship between effect modes and texture information, the method further includes: determining, based on an effect mode corresponding to the target image, the object position information, the object rendering information, and the object display information corresponding to each of at least one effect object; storing, for each effect object, the object position information, the object rendering information, and the object display information of the effect object through the color channel of the at least one texture pixel to generate the texture information corresponding to the target image; and establishing the correspondence relationship between the effect modes and the texture information.

In some embodiments, the number of the at least one texture pixel is one; and color channel of the texture pixel include a red information channel, a green information channel, a blue information channel, and a transparency information channel. Correspondingly, storing, for each effect object, the object position information, the object rendering information, and the object display information of the effect object through the color channel of the at least one texture pixel to generate the texture information corresponding to the target image includes: for each effect object, storing the X-coordinate information in the object position information through the red information channel of one texture pixel, storing the Y-coordinate information in the object position information through the green information channel of the texture pixel, storing the object rendering information through the blue information channel of the texture pixel, and storing the object display information through the transparency information channel of the texture pixel; and establishing a correspondence relationship between effect objects and texture pixels to generate the texture information corresponding to the image effect information.

In some other embodiments, the at least one texture pixel includes a first texture pixel and a second texture pixel which are adjacent in position. Correspondingly, storing, for each effect object, the object position information, the object rendering information, and the object display information of the effect object through the color channel of the at least one texture pixel to generate the texture information corresponding to the target image includes: for each effect object, storing the X-coordinate information in the object position information through a red information channel and a green information channel of the first texture pixel, storing the Y-coordinate information in the object position information through a blue information channel and a transparency information channel of the first texture pixel, storing the object rendering information through a red information channel and a green information channel of the second texture pixel, and storing the object display information through a blue information channel of the second texture pixel; and establishing a correspondence relationship between the effect objects and the first texture pixel and the second texture pixel, to generate the texture information corresponding to the image effect information.

Exemplarily, as shown in FIG. 4, the texture image includes 128*64 texture pixels. The red information channel and the green information channel of the first texture pixel store the X-coordinate information (128, 64) in the object position information, the blue information channel and the transparency information channel of the first texture pixel store the Y-coordinate information (60, 220) in the object position information, the red information channel and the green information channel of the second texture pixel store the object rendering information (2, 212), and the blue information channel of the second texture pixel stores the object display information (255).

The object rendering information may be represented as: weight. The object display information may be represented as: flag. The transparency information channel of the second texture pixel does not store information, which may be represented as: null.

In this embodiment of the present disclosure, the rendering information corresponding to each effect object is stored through the color channels of the two texture pixels, thereby improving the accuracy of information storage.

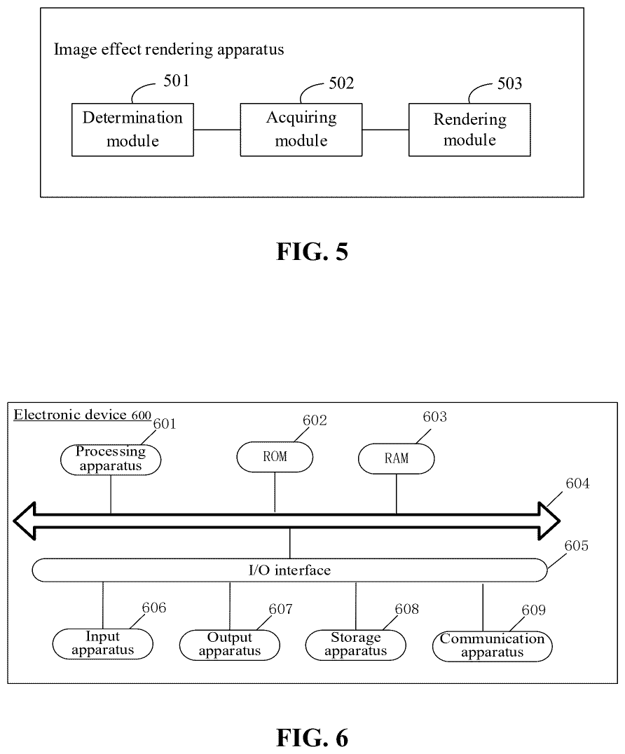

FIG. 5 is a schematic structural diagram of an image effect rendering apparatus according to an embodiment of the present disclosure. As shown in FIG. 5, the image effect rendering apparatus includes:
a determination module 501 configured to determine, in response to an effect rendering operation on a target image, texture information corresponding to the target image;
an acquiring module 502 configured to acquire image effect information corresponding to the target image from the texture information, where the image effect information includes object position information, object rendering information, and object display information of at least one effect object; and
a rendering module 503 configured to render the target image based on the object position information, the object rendering information, and the object display information of the at least one effect object included in the image effect information.

According to one or more embodiments of the present disclosure, rendering, by the rendering module 503, the target image based on the object position information, the object rendering information, and the object display information of the at least one effect object included in the image effect information includes: for each effect object, in response to the object display information being used for indicating displaying of the effect object, determining a rendering region of the effect object based on the object position information and the object rendering information of the effect object, and rendering the effect object in the rendering region; and in response to the object display information being used for indicating not displaying the effect object, not rendering the effect object.

According to one or more embodiments of the present disclosure, determining, by the rendering module 503, the rendering region of the effect object based on the object position information and the object rendering information of the effect object, and rendering the effect object in the rendering region includes: in response to the object rendering information including an object rendering area, determining the rendering region of the effect object based on the object rendering area of the effect object, and rendering the effect object in the rendering region; and in response to the object rendering information including a rendering transparency, determining the rendering region of the effect object based on the object position information and a preset object rendering area, and rendering the effect object in the rendering region based on the rendering transparency.

According to one or more embodiments of the present disclosure, acquiring, by the acquiring module 502, the image effect information corresponding to the target image from the texture information includes: determining a three-dimensional grid model corresponding to the target image, where the three-dimensional grid model includes a plurality of grid vertices, and each grid vertex corresponds to a grid region; acquiring, for each grid vertex, the object position information, the object rendering information, and the object display information of the target effect object corresponding to the grid vertex from the texture information based on texture coordinates of the grid vertex in the texture information; and determining the object position information, the object rendering information, and the object display information of respective target effect objects corresponding to the plurality of grid vertices as the image effect information corresponding to the target image.

According to one or more embodiments of the present disclosure, acquiring, by the acquiring module 502, for each grid vertex, the object position information, the object rendering information, and the object display information of the target effect object corresponding to the grid vertex from the texture information based on texture coordinates of the grid vertex in the texture information includes: for each grid vertex, determining at least one texture pixel corresponding to the grid vertex from the texture information based on texture coordinates of the grid vertex in the texture information; and acquiring the object position information, the object rendering information, and the object display information of the target effect object corresponding to the grid vertex from a color channel of the at least one texture pixel.

According to one or more embodiments of the present disclosure, a number of the at least one texture pixel is one; and color channel of the texture pixel include a red information channel, a green information channel, a blue information channel, and a transparency information channel. Correspondingly, acquiring, by the acquiring module 502, the object position information, the object rendering information, and the object display information of the target effect object corresponding to the grid vertex from a color channel of the at least one texture pixel includes: acquiring X-coordinate information in the object position information of the target effect object from the red information channel of the texture pixel; acquiring Y-coordinate information in the object position information of the target effect object from the green information channel of the texture pixel; acquiring the object rendering information of the target effect object from the blue information channel of the texture pixel; and acquiring the object display information of the target effect object from the transparency information channel of the texture pixel.

According to one or more embodiments of the present disclosure, the at least one texture pixel includes a first texture pixel and a second texture pixel which are adjacent in position. Correspondingly, acquiring, by the acquiring module 502, the object position information, the object rendering information, and the object display information of the target effect object corresponding to the grid vertex from the color channel of the at least one texture pixel includes: acquiring the X-coordinate information in the object position information of the target effect object from a red information channel and a green information channel of the first texture pixel; acquiring the Y-coordinate information in the object position information of the target effect object from a blue information channel and a transparency information channel of the first texture pixel; acquiring the object rendering information of the target effect object from a red information channel and a green information channel of the second texture pixel; and acquiring the object display information of the target effect object from a blue information channel of the second texture pixel.

According to one or more embodiments of the present disclosure, determining, by the determination module 501, in response to the effect rendering operation on the target image, the texture information corresponding to the target image includes: determining an effect mode corresponding to the effect rendering operation in response to the effect rendering operation on the target image; and determining the texture information corresponding to the target image from a correspondence relationship between effect modes and texture information.

According to one or more embodiments of the present disclosure, the apparatus further includes: a generation module configured to determine, based on an effect mode corresponding to the target image, the object position information, the object rendering information, and the object display information corresponding to each of at least one effect object; store, for each effect object, the object position information, the object rendering information, and the object display information of the effect object through a color channel of at least one texture pixel, and generate texture information corresponding to the target image; and establish the correspondence relationship between the effect modes and the texture information.

Referring to FIG. 6, FIG. 6 illustrates a schematic structural diagram of an electronic device 600 applicable to implementing embodiments of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer, a portable media player (PMP), and a vehicle-mounted terminal (e.g., a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit and a graphics processing unit) 601, which may perform various appropriate actions and processing based on programs stored in a read only memory (ROM) 602 or loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Typically, the following apparatuses may be connected to the I/O interface 605: an input apparatus 606, including, for example, a touchscreen, a touchpad, a keyboard, a mouse, a camera, a microphone, an accelerometer, and a gyroscope; an output apparatus 607, including, for example, a liquid crystal display (LCD), a speaker, and a vibrator; the storage apparatus 608, including, for example, a magnetic tape and a hard drive; and a communication apparatus 609. The communication apparatus 609 may allow the electronic device 600 to be in wireless or wired communication with other devices for data exchange. Although FIG. 6 shows the electronic device 600 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product including a computer program carried on a computer-readable medium. The computer program includes program code for performing the method shown in the flowchart. In this embodiment, the computer program may be downloaded and installed from the network through the communication apparatus 609, installed from the storage apparatus 608, or installed from the ROM 602. The computer program, when executed by the processing apparatus 601, performs the above-mentioned functions limited in the method in this embodiment of the present disclosure.

It should be noted that the above-mentioned computer-readable medium in the present disclosure may be either a computer-readable signal medium or a computer-readable storage medium, or any combination of the two. The computer-readable storage medium may be, for example but is not limited to, electric, magnetic, optical, electromagnetic, infrared, or semiconductor systems, apparatuses, or devices, or any combination thereof. More specific examples of the computer-readable storage medium may include, but are not limited to: an electrical connection with one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer-readable storage medium may be any tangible medium including or storing a program, and the program may be for use by or for use in conjunction with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in conjunction with the instruction execution system, apparatus, or device. The program code included in the computer-readable medium may be transmitted by any suitable medium, including but not limited to a wire, an optical cable, radio frequency (RF), etc., or any suitable combination of the above.

The above-mentioned computer-readable medium may be included in the above-mentioned electronic device; or may also separately exist without being assembled in the electronic device.

The above-mentioned computer-readable medium carries one or more programs. The above-mentioned one or more programs, when executed by the electronic device, cause the electronic device to perform the method shown in the above-mentioned embodiments.

Computer program code for performing the operations in the present disclosure may be written in one or more programming languages or a combination thereof, where the above-mentioned programming languages include an object-oriented programming language, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer via any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit does not constitute a limitation on the unit itself in some cases. For example, a first acquiring unit may also be described as a “unit for acquiring at least two Internet protocol addresses”.

Herein, the functions described above may be at least partially executed by one or more hardware logic components. For example, without limitation, exemplary hardware logic components that can be used include: a field-programmable gate array (FPGA), an application-specific integrated circuit (ASIC), an application-specific standard product (ASSP), a system on chip (SOC), a complex programmable logic device (CPLD), etc.

In the context of the present disclosure, a machine-readable medium may be a tangible medium that may include or store a program for use by or for use in conjunction with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above-mentioned content. More specific examples of the machine-readable storage medium may include an electrical connection based on one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above-mentioned content.

In a first aspect, according to one or more embodiments of the present disclosure, an image effect rendering method is provided, and includes:
determining, in response to an effect rendering operation on a target image, texture information corresponding to the target image;
acquiring image effect information corresponding to the target image from the texture information, where the image effect information includes object position information, object rendering information, and object display information of at least one effect object; and
rendering the target image based on the object position information, the object rendering information, and the object display information of the at least one effect object included in the image effect information.

According to one or more embodiments of the present disclosure, rendering the target image based on the object position information, the object rendering information, and the object display information of the at least one effect object included in the image effect information includes: for each effect object, in response to the object display information being used for indicating displaying the effect object, determining a rendering region of the effect object based on the object position information and the object rendering information of the effect object, and rendering the effect object in the rendering region; and in response to the object display information being used for indicating not displaying the effect object, not rendering the effect object.

According to one or more embodiments of the present disclosure, determining the rendering region of the effect object based on the object position information and the object rendering information of the effect object, and rendering the effect object in the rendering region includes: in response to the object rendering information including an object rendering area, determining the rendering region of the effect object based on the object rendering area of the effect object, and rendering the effect object in the rendering region; and in response to the object rendering information including a rendering transparency, determining the rendering region of the effect object based on the object position information and a preset object rendering area, and rendering the effect object in the rendering region based on the rendering transparency.

According to one or more embodiments of the present disclosure, acquiring image effect information corresponding to the target image from the texture information includes: determining a three-dimensional grid model corresponding to the target image, where the three-dimensional grid model includes a plurality of grid vertices, and each grid vertex corresponds to a grid region; acquiring, for each grid vertex, the object position information, the object rendering information, and the object display information of the target effect object corresponding to the grid vertex from the texture information based on texture coordinates of the grid vertex in the texture information; and determining the object position information, the object rendering information, and the object display information of respective target effect objects corresponding to the plurality of grid vertices as the image effect information corresponding to the target image.

According to one or more embodiments of the present disclosure, acquiring, for each grid vertex, the object position information, the object rendering information, and the object display information of the target effect object corresponding to the grid vertex from the texture information based on texture coordinates of the grid vertex in the texture information includes: for each grid vertex, determining at least one texture pixel corresponding to the grid vertex from the texture information based on texture coordinates of the grid vertex in the texture information; and acquiring the object position information, the object rendering information, and the object display information of the target effect object corresponding to the grid vertex from a color channel of the at least one texture pixel.

According to one or more embodiments of the present disclosure, a number of the at least one texture pixel is one; and the color channel of the texture pixel include a red information channel, a green information channel, a blue information channel, and a transparency information channel. Correspondingly, acquiring the object position information, the object rendering information, and the object display information of the target effect object corresponding to the grid vertex from the color channel of the at least one texture pixel includes: acquiring X-coordinate information in the object position information of the target effect object from the red information channel of the texture pixel; acquiring Y-coordinate information in the object position information of the target effect object from the green information channel of the texture pixel; acquiring the object rendering information of the target effect object from the blue information channel of the texture pixel; and acquiring the object display information of the target effect object from the transparency information channel of the texture pixel.

According to one or more embodiments of the present disclosure, the at least one texture pixel includes a first texture pixel and a second texture pixel which are adjacent in position. Correspondingly, the step of acquiring the object position information, the object rendering information, and the object display information of the target effect object corresponding to the grid vertex from a color channel of the at least one texture pixel includes: acquiring the X-coordinate information in the object position information of the target effect object from a red information channel and a green information channel of the first texture pixel; acquiring the Y-coordinate information in the object position information of the target effect object from a blue information channel and a transparency information channel of the first texture pixel; acquiring the object rendering information of the target effect object from a red information channel and a green information channel of the second texture pixel; and acquiring the object display information of the target effect object from a blue information channel of the second texture pixel.

According to one or more embodiments of the present disclosure, determining, in response to the effect rendering operation on the target image, the texture information corresponding to the target image includes: determining an effect mode corresponding to the effect rendering operation in response to the effect rendering operation on the target image; and determining the texture information corresponding to the target image from a correspondence relationship between effect modes and texture information.

According to one or more embodiments of the present disclosure, before determining the texture information corresponding to the target image from the correspondence relationship between effect modes and texture information, the method further includes: determining, based on an effect mode corresponding to the target image, the object position information, the object rendering information, and the object display information corresponding to each of at least one effect object; storing, for each effect object, the object position information, the object rendering information, and the object display information of the effect object through the color channel of the at least one texture pixel, and generating the texture information corresponding to the target image; and establishing the correspondence relationship between the effect modes and the texture information.

In a second aspect, according to one or more embodiments of the present disclosure, an image effect rendering apparatus is provided, and includes:
a determination module configured to determine, in response to an effect rendering operation on a target image, texture information corresponding to the target image;
an acquiring module configured to acquire image effect information corresponding to the target image from the texture information, where the image effect information includes object position information, object rendering information, and object display information of at least one effect object; and
a rendering module configured to render the target image based on the object position information, the object rendering information, and the object display information of the at least one effect object included in the image effect information.

According to one or more embodiments of the present disclosure, rendering, by the rendering module, the target image based on the object position information, the object rendering information, and the object display information of the at least one effect object included in the image effect information includes: for each effect object, in response to the object display information being used for indicating displaying the effect object, determining a rendering region of the effect object based on the object position information and the object rendering information of the effect object, and rendering the effect object in the rendering region; and in response to the object display information being used for indicating not displaying the effect object, not rendering the effect object.

According to one or more embodiments of the present disclosure, determining, by the rendering module, the rendering region of the effect object based on the object position information and the object rendering information of the effect object, and rendering the effect object in the rendering region includes: in response to the object rendering information including an object rendering area, determining the rendering region of the effect object based on the object rendering area of the effect object, and rendering the effect object in the rendering region; and in response to the object rendering information including a rendering transparency, determining the rendering region of the effect object based on the object position information and a preset object rendering area, and rendering the effect object in the rendering region based on the rendering transparency.

According to one or more embodiments of the present disclosure, acquiring, by the acquiring module, the image effect information corresponding to the target image from the texture information includes: determining a three-dimensional grid model corresponding to the target image, where the three-dimensional grid model includes a plurality of grid vertices, and each grid vertex corresponds to a grid region; acquiring, for each grid vertex, the object position information, the object rendering information, and the object display information of the target effect object corresponding to the grid vertex from the texture information based on texture coordinates of the grid vertex in the texture information; and determining the object position information, the object rendering information, and the object display information of respective target effect objects corresponding to the plurality of grid vertices as the image effect information corresponding to the target image.

According to one or more embodiments of the present disclosure, acquiring, by the acquiring module, for each grid vertex, the object position information, the object rendering information, and the object display information of the target effect object corresponding to the grid vertex from the texture information based on texture coordinates of the grid vertex in the texture information includes: for each grid vertex, determining at least one texture pixel corresponding to the grid vertex from the texture information based on texture coordinates of the grid vertex in the texture information; and acquiring the object position information, the object rendering information, and the object display information of the target effect object corresponding to the grid vertex from a color channel of the at least one texture pixel.

According to one or more embodiments of the present disclosure, a number of the at least one texture pixel is one; and the color channel of the texture pixel include a red information channel, a green information channel, a blue information channel, and a transparency information channel. Correspondingly, acquiring, by the acquiring module, the object position information, the object rendering information, and the object display information of the target effect object corresponding to the grid vertex from the color channel of the at least one texture pixel includes: acquiring X-coordinate information in the object position information of the target effect object from the red information channel of the texture pixel; acquiring Y-coordinate information in the object position information of the target effect object from the green information channel of the texture pixel; acquiring the object rendering information of the target effect object from the blue information channel of the texture pixel; and acquiring the object display information of the target effect object from the transparency information channel of the texture pixel.

According to one or more embodiments of the present disclosure, the at least one texture pixel includes a first texture pixel and a second texture pixel which are adjacent in position. Correspondingly, acquiring, by the acquiring module, the object position information, the object rendering information, and the object display information of the target effect object corresponding to the grid vertex from the color channel of the at least one texture pixel includes: acquiring the X-coordinate information in the object position information of the target effect object from a red information channel and a green information channel of the first texture pixel; acquiring the Y-coordinate information in the object position information of the target effect object from a blue information channel and a transparency information channel of the first texture pixel; acquiring the object rendering information of the target effect object from a red information channel and a green information channel of the second texture pixel; and acquiring the object display information of the target effect object from a blue information channel of the second texture pixel.

According to one or more embodiments of the present disclosure, determining, by the determination module, in response to the effect rendering operation on the target image, the texture information corresponding to the target image includes: determining an effect mode corresponding to the effect rendering operation in response to the effect rendering operation on the target image; and determining the texture information corresponding to the target image from a correspondence relationship between effect modes and texture information.

According to one or more embodiments of the present disclosure, the apparatus further includes: a generation module configured to determine, based on an effect mode corresponding to the target image, the object position information, the object rendering information, and the object display information corresponding to each of at least one effect object; store, for each effect object, the object position information, the object rendering information, and the object display information of the effect object through a color channel of at least one texture pixel, and generate texture information corresponding to the target image; and establish the correspondence relationship between the effect modes and the texture information.

In a third aspect, according to one or more embodiments of the present disclosure, an electronic device is provided. The electronic device includes at least one processor and a memory.

The memory stores computer-executable instructions.

The at least one processor executes the computer-executable instructions stored in the memory, to cause the at least one processor to perform the image effect rendering method according to the first aspect and various possible designs in the first aspect described above.

In a fourth aspect, according to one or more embodiments of the present disclosure, a computer-readable storage medium is provided. The computer-readable storage medium stores computer-executable instructions which, when executed by a processor, implement the image effect rendering method according to the first aspect and various possible designs in the first aspect described above.

In a fifth aspect, according to one or more embodiments of the present disclosure, a computer program product is provided, and includes a computer program. The computer program, when executed by a processor, implements the image effect rendering method according to the first aspect and various possible designs in the first aspect described above.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned concept of disclosure. For example, a technical solution formed by a replacement of the above-mentioned features with technical features with similar functions disclosed in the present disclosure (but not limited thereto) also falls within the scope of the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above-mentioned discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. An image effect rendering method, comprising:
determining, in response to an effect rendering operation on a target image, texture information corresponding to the target image;
acquiring image effect information corresponding to the target image from the texture information, wherein the image effect information comprises object position information, object rendering information, and object display information of at least one effect object; and
rendering the target image based on the object position information, the object rendering information, and the object display information of the at least one effect object comprised in the image effect information.

2. The method according to claim 1, wherein rendering the target image based on the object position information, the object rendering information, and the object display information of the at least one effect object comprised in the image effect information comprises:
for each effect object, in response to the object display information being used for indicating displaying the effect object, determining a rendering region of the effect object based on the object position information and the object rendering information of the effect object, and rendering the effect object in the rendering region; and
in response to the object display information being used for indicating not displaying the effect object, not rendering the effect object.

3. The method according to claim 2, wherein determining the rendering region of the effect object based on the object position information and the object rendering information of the effect object, and rendering the effect object in the rendering region comprises:
in response to the object rendering information comprising an object rendering area, determining the rendering region of the effect object based on the object rendering area of the effect object, and rendering the effect object in the rendering region; and
in response to the object rendering information comprising a rendering transparency, determining the rendering region of the effect object based on the object position information and a preset object rendering area, and rendering the effect object in the rendering region based on the rendering transparency.

4. The method according to claim 1, wherein acquiring the image effect information corresponding to the target image from the texture information comprises:
determining a three-dimensional grid model corresponding to the target image, wherein the three-dimensional grid model comprises a plurality of grid vertices, and each grid vertex corresponds to a grid region;
acquiring, for each grid vertex, object position information, object rendering information, and object display information of a target effect object corresponding to the grid vertex from the texture information based on texture coordinates of the grid vertex in the texture information; and
determining the object position information, the object rendering information, and the object display information of respective target effect objects corresponding to the plurality of grid vertices as the image effect information corresponding to the target image.

5. The method according to claim 4, wherein acquiring, for each grid vertex, the object position information, the object rendering information, and the object display information of the target effect object corresponding to the grid vertex from the texture information based on the texture coordinates of the grid vertex in the texture information comprises:
for each grid vertex, determining at least one texture pixel corresponding to the grid vertex from the texture information based on the texture coordinates of the grid vertex in the texture information; and
acquiring the object position information, the object rendering information, and the object display information of the target effect object corresponding to the grid vertex from a color channel of the at least one texture pixel.

6. The method according to claim 5, wherein a number of the at least one texture pixel is one, and the color channel of the texture pixel comprises a red information channel, a green information channel, a blue information channel, and a transparency information channel; and
acquiring the object position information, the object rendering information, and the object display information of the target effect object corresponding to the grid vertex from the color channel of the at least one texture pixel correspondingly comprises:
acquiring X-coordinate information in the object position information of the target effect object from the red information channel of the texture pixel;
acquiring Y-coordinate information in the object position information of the target effect object from the green information channel of the texture pixel;
acquiring the object rendering information of the target effect object from the blue information channel of the texture pixel; and
acquiring the object display information of the target effect object from the transparency information channel of the texture pixel.

7. The method according to claim 5, wherein the at least one texture pixel comprises a first texture pixel and a second texture pixel which are adjacent in position; and
acquiring the object position information, the object rendering information, and the object display information of the target effect object corresponding to the grid vertex from the color channel of the at least one texture pixel correspondingly comprises:
acquiring X-coordinate information in the object position information of the target effect object from a red information channel and a green information channel of the first texture pixel;
acquiring Y-coordinate information in the object position information of the target effect object from a blue information channel and a transparency information channel of the first texture pixel;
acquiring the object rendering information of the target effect object from a red information channel and a green information channel of the second texture pixel; and
acquiring the object display information of the target effect object from a blue information channel of the second texture pixel.

8. The method according to claim 1, wherein determining, in response to the effect rendering operation on the target image, the texture information corresponding to the target image comprises:
determining an effect mode corresponding to the effect rendering operation in response to the effect rendering operation on the target image; and
determining the texture information corresponding to the target image from a correspondence relationship between the effect mode and the texture information.

9. The method according to claim 8, wherein before determining the texture information corresponding to the target image from the correspondence relationship between the effect mode and the texture information, the method further comprises:
determining, based on an effect mode corresponding to the target image, the object position information, the object rendering information, and the object display information corresponding to each of the at least one effect object;
storing, for each effect object, the object position information, the object rendering information, and the object display information of the effect object through a color channel of at least one texture pixel, and generating the texture information corresponding to the target image; and
establishing the correspondence relationship between the effect mode and the texture information.

10. An electronic device, comprising:
a processor and a memory,
wherein the memory stores computer-executable instructions; and
the processor executes the computer-executable instructions stored in the memory, to configure the processor to:
determine, in response to an effect rendering operation on a target image, texture information corresponding to the target image;
acquire image effect information corresponding to the target image from the texture information, wherein the image effect information comprises object position information, object rendering information, and object display information of at least one effect object; and
render the target image based on the object position information, the object rendering information, and the object display information of the at least one effect object comprised in the image effect information.

11. The electronic device according to claim 10, wherein the computer-executable instructions to configure the processor to render the target image based on the object position information, the object rendering information, and the object display information of the at least one effect object comprised in the image effect information comprise computer-executable instructions to configure the processor to:
for each effect object, in response to the object display information being used for indicating displaying the effect object, determine a rendering region of the effect object based on the object position information and the object rendering information of the effect object, and render the effect object in the rendering region; and
in response to the object display information being used for indicating not displaying the effect object, not render the effect object.

12. The electronic device according to claim 11, wherein the computer-executable instructions to configure the processor to determine the rendering region of the effect object based on the object position information and the object rendering information of the effect object, and render the effect object in the rendering region comprise computer-executable instructions to configure the processor to:
in response to the object rendering information comprising an object rendering area, determine the rendering region of the effect object based on the object rendering area of the effect object, and render the effect object in the rendering region; and
in response to the object rendering information comprising a rendering transparency, determine the rendering region of the effect object based on the object position information and a preset object rendering area, and render the effect object in the rendering region based on the rendering transparency.

13. The electronic device according to claim 10, wherein the computer-executable instructions to configure the processor to acquire the image effect information corresponding to the target image from the texture information comprise computer-executable instructions to configure the processor to:
determine a three-dimensional grid model corresponding to the target image, wherein the three-dimensional grid model comprises a plurality of grid vertices, and each grid vertex corresponds to a grid region;
acquire, for each grid vertex, object position information, object rendering information, and object display information of a target effect object corresponding to the grid vertex from the texture information based on texture coordinates of the grid vertex in the texture information; and
determine the object position information, the object rendering information, and the object display information of respective target effect objects corresponding to the plurality of grid vertices as the image effect information corresponding to the target image.

14. The electronic device according to claim 13, wherein the computer-executable instructions to configure the processor to acquire, for each grid vertex, the object position information, the object rendering information, and the object display information of the target effect object corresponding to the grid vertex from the texture information based on the texture coordinates of the grid vertex in the texture information comprise computer-executable instructions to configure the processor to:
for each grid vertex, determine at least one texture pixel corresponding to the grid vertex from the texture information based on the texture coordinates of the grid vertex in the texture information; and
acquire the object position information, the object rendering information, and the object display information of the target effect object corresponding to the grid vertex from a color channel of the at least one texture pixel.

15. The electronic device according to claim 14, wherein a number of the at least one texture pixel is one, and the color channel of the texture pixel comprises a red information channel, a green information channel, a blue information channel, and a transparency information channel; and
the computer-executable instructions to configure the processor to acquire the object position information, the object rendering information, and the object display information of the target effect object corresponding to the grid vertex from the color channel of the at least one texture pixel correspondingly comprise computer-executable instructions to configure the processor to:
acquire X-coordinate information in the object position information of the target effect object from the red information channel of the texture pixel;
acquire Y-coordinate information in the object position information of the target effect object from the green information channel of the texture pixel;
acquire the object rendering information of the target effect object from the blue information channel of the texture pixel; and
acquire the object display information of the target effect object from the transparency information channel of the texture pixel.

16. The electronic device according to claim 14, wherein the at least one texture pixel comprises a first texture pixel and a second texture pixel which are adjacent in position; and
the computer-executable instructions to configure the processor to acquire the object position information, the object rendering information, and the object display information of the target effect object corresponding to the grid vertex from the color channel of the at least one texture pixel correspondingly comprise computer-executable instructions to configure the processor to:
acquire X-coordinate information in the object position information of the target effect object from a red information channel and a green information channel of the first texture pixel;
acquire Y-coordinate information in the object position information of the target effect object from a blue information channel and a transparency information channel of the first texture pixel;
acquire the object rendering information of the target effect object from a red information channel and a green information channel of the second texture pixel; and
acquire the object display information of the target effect object from a blue information channel of the second texture pixel.

17. The electronic device according to claim 10, wherein the computer-executable instructions to configure the processor to determine, in response to the effect rendering operation on the target image, the texture information corresponding to the target image comprise computer-executable instructions to configure the processor to:
determine an effect mode corresponding to the effect rendering operation in response to the effect rendering operation on the target image; and
determine the texture information corresponding to the target image from a correspondence relationship between the effect mode and the texture information.

18. The electronic device according to claim 17, wherein before the computer-executable instructions to configure the processor to determine the texture information corresponding to the target image from the correspondence relationship between the effect mode and the texture information, the computer-executable instructions further configure the processor to:
determine, based on an effect mode corresponding to the target image, the object position information, the object rendering information, and the object display information corresponding to each of the at least one effect object;
store, for each effect object, the object position information, the object rendering information, and the object display information of the effect object through a color channel of at least one texture pixel, and generate the texture information corresponding to the target image; and
establish the correspondence relationship between the effect mode and the texture information.

19. A non-transitory computer-readable storage medium, storing computer-executable instructions which, when executed by a processor, configure the processor to:
determine, in response to an effect rendering operation on a target image, texture information corresponding to the target image;
acquire image effect information corresponding to the target image from the texture information, wherein the image effect information comprises object position information, object rendering information, and object display information of at least one effect object; and
render the target image based on the object position information, the object rendering information, and the object display information of the at least one effect object comprised in the image effect information.

20. The non-transitory computer-readable storage medium according to claim 19, wherein the computer-executable instructions configuring the processor to render the target image based on the object position information, the object rendering information, and the object display information of the at least one effect object comprised in the image effect information comprise computer-executable instructions to configure the processor to:
for each effect object, in response to the object display information being used for indicating displaying the effect object, determine a rendering region of the effect object based on the object position information and the object rendering information of the effect object, and render the effect object in the rendering region; and
in response to the object display information being used for indicating not displaying the effect object, not render the effect object.
